(19) United States
(12) Patent Application Publication
(10) Pub. No.: US 2026/0320610 A1
(43) Pub. Date: Oct. 15, 2026

(54) MANAGEMENT SYSTEM AND METHOD FOR DIGITAL ASSETS

(71) Applicants: NET ALLIANCE CO., LTD., NEW TAIPEI CITY (TW); CHI-CHING CHEN, NEW TAIPEI CITY (TW)

(72) Inventor: CHI-CHING CHEN, NEW TAIPEI CITY (TW)

(21) Appl. No.: 19/461,863

(22) Filed: Jan. 28, 2026

Related U.S. Application Data
(63) Continuation-in-part of application No. 18/390,429, filed on Dec. 20, 2023.

(30) Foreign Application Priority Data
Sep. 28, 2023 (TW) 112137793

(51) Int. Cl. G06Q 20/40; G06Q 20/06; G06Q 20/34; G06Q 20/38; H04L 9/40

(52) U.S. Cl. CPC G06Q 20/40145; G06Q 20/065; G06Q 20/341; G06Q 20/3829; G06Q 20/389; H04L 63/0846; G06Q 2220/00

(57) ABSTRACT

The present disclosure provides a digital asset management system, which comprises a financial account management platform, an exchange platform, a regulatory platform, and a physical card. The physical card is equipped with a first chip module and a second chip module. When conducting a digital asset transaction, the user places the physical card on a chip reading device to activate both chip modules. The first chip module establishes a secure connection with the financial account management platform to perform financial identity verification. The second chip module establishes a secure connection with the regulatory platform to perform authorization review of the digital asset transaction. When the financial identity authentication and the authorization review of the digital asset transaction are verified, the regulatory platform issues an authorized transaction instruction to the financial account management platform and the exchange platform to permit the execution of the digital asset transaction.

This application is a continuation-in-part of and claims priority to U.S. Patent Application No. 18/390,429, filed on Dec. 20, 2023, the contents of which are hereby incorporated by reference in their entirety.

### FIELD OF THE INVENTION

The present invention relates to a digital asset management system and a management method, which authorize the initiation of digital asset transactions through a physical card, and further cooperate with an independent regulatory authority to supervise the transaction process of digital assets, thereby enhancing the security of digital asset transactions.

### BACKGROUND

Please refer to FIG. 1, there is shown a schematic structural diagram of a conventional digital asset management system. The digital asset management system 100 includes a communication device 11, a financial institution 13, and a digital asset exchange 15. The communication device 11 is held by a user and is network-connected to the financial institution 13 and the digital asset exchange 15.

Through a communication device 11, a user applies to a financial institution 13 (e.g., a banking institution) for a financial account 131. Furthermore, through the communication device 11, the user applies to a digital asset exchange 15 for a transaction account 151. The digital asset exchange 15 may be a cryptocurrency exchange such as Bitfinex, Binance, Coinbase, FTX, BYbit, Kraken, Bitstamp, or Gemini.

When a user intends to purchase a digital asset 12 (such as stablecoins, Bitcoin, Ethereum, other cryptocurrencies, or non-fungible tokens (NFTs)), the user may, according to the quantity of the digital asset 12 to be purchased, request the financial institution 13 to remit a corresponding transaction amount from the financial account 131 to the transaction account 151 of the digital asset exchange 15. Upon receiving the aforementioned transaction amount, the digital asset exchange 15 executes a purchase process for the digital asset 12 on a blockchain 17 to obtain the corresponding quantity of the digital asset 12. The transaction record of the digital asset 12 is recorded in a distributed ledger of the blockchain 17, while digital asset–related information 121 (e.g., a blockchain address on the blockchain 17 that records ownership of the digital asset 12, smart contract identification information, transaction record indices, or other data related to the management of the digital asset 12) is stored in an internal custody system of the digital asset exchange 15, thereby enabling the digital asset exchange 15 to perform management, transaction, or inquiry operations with respect to the digital asset 12.

Conversely, when a user intends to sell a digital asset 12 held by the user, the user submits a sell request to the digital asset exchange 15 via the communication device 11. Upon receiving the sell request, the digital asset exchange 15 deducts a corresponding balance of the digital asset 12 from an internal ledger of the digital asset exchange 15 according to a selected type and quantity of the digital asset 12 to be sold, and submits a sell order for the digital asset 12 to a matching system of a transaction platform. After matching is completed, a resulting consideration amount (e.g., fiat currency or an equivalent accounting amount) is recorded in the user's transaction account 151. When the user submits a withdrawal application, the digital asset exchange 15, in response to the withdrawal application, prompts the financial institution 13 to remit the consideration amount from the user's transaction account 151 to the user's financial account 131, thereby completing the sale transaction of the digital asset 12.

In the past, both the transaction matching of digital assets 12 and the custody of private keys 120 associated with said digital assets 12 are managed by a single entity, namely, the digital asset exchange 15 was responsible for both buy/sell matching of the digital assets 12 and asset custody. However, such centralized management of transactions and custody poses significant risks. Specifically, internal mismanagement or malicious operations within the single entity may render the private keys 120 custodially held by the exchange 15 vulnerable to unauthorized access or misappropriation, thereby resulting in the potential for illegal transfer or illicit transaction of the digital assets 12.

Numerous high-profile incidents have underscored the structural vulnerabilities of conventional digital asset management system in terms of asset custody and internal governance. A notable instance is the 2014 collapse of the Mt. Gox exchange, which led to the loss of approximately 850,000 Bitcoins, largely due to centralized private key management and internal security flaws. Furthermore, the 2022 FTX collapse resulted in an estimated USD 8 billion deficit in client funds, stemming from systemic failures in independent oversight, internal controls, and the unauthorized handling of private keys.

Specifically, the conventional digital asset management system 100 lacks a credible oversight mechanism. A single exchange is responsible for both transaction matching and the management of accounts and private keys 120 for digital assets 12. This concentration of authority allows internal operations to bypass independent supervision, thereby increasing the risk of misappropriation of the digital assets 12.

Alternatively, to mitigate the risk of misappropriation of the digital asset 12, a user may choose to transfer the digital asset 12 custodially held in the transaction account 151 of the digital asset exchange 15 to a personal wallet 19 (e.g., a hot wallet or a cold wallet) controlled by the user via an on-chain transaction. The specific transfer process is as follows: upon the user's submission of a transfer request, the digital asset exchange 15 executes a blockchain transaction from a hot or cold wallet for which the exchange controls the private keys to transfer the digital asset 12 to a blockchain address designated by the personal wallet 19. Since the personal wallet 19 is non-custodial, the user maintains full control over the private key 120 corresponding to the blockchain address and is thus able to independently manage and dispose of the digital asset 12. However, the primary risk of a non-custodial wallet is that if the personal wallet 19 is damaged, or if the user loses or leaks the private key 120, the digital asset 12 associated with that address will become inaccessible or untransferable, potentially resulting in the permanent loss of the user’s digital asset investment.

In view of the foregoing, the present invention is directed to establishing a digital asset management architecture in which transaction responsibilities and oversight responsibilities are separated, thereby enhancing the security and reliability of digital asset management.

### SUMMARY OF THE INVENTION

It is one objective of the present disclosure to provide a digital asset management system, which comprises a financial account management platform that establishes a financial account, a digital asset transaction platform that establishes a transaction account, and a digital asset regulatory platform that establishes a regulatory account. The digital asset management system further includes a physical card having a first chip module and a second chip module. When a user intends to perform a digital asset transaction, the physical card is placed on a chip reading device to activate the first chip module and the second chip module. The activated first chip module establishes a secure connection with a financial transaction module of the financial account management platform to perform financial identity verification of the user. The activated second chip module establishes a secure connection with a digital asset regulatory module of the digital asset regulatory platform to perform an authorization review of the digital asset transaction. When the financial identity verification and the authorization review are successfully verified, the digital asset regulatory module of the digital asset regulatory platform issues an authorized transaction instruction to a digital asset transaction module of the digital asset transaction platform and the financial transaction module of the financial account management platform to allow the digital asset transaction module and the financial transaction module to execute the digital asset transaction. In this manner, the transaction of digital assets is authorized and initiated through a physical card, and the transaction process is supervised by an independent regulatory entity, thereby enhancing the security of digital asset transactions.

It is another objective of the present disclosure to provide a digital asset management system, wherein the transactions of digital assets are handled by a digital asset transaction platform, while the custody of digital assets and regulation of the transaction process are handled by a digital asset regulatory platform. By implementing this separation of duties between transaction and digital asset custody, the present disclosure achieves enhanced digital asset security and risk management. Compared to traditional models in which custody is managed internally by the exchange, the present disclosure ensures that transaction execution and asset custody are independent of each other. This separation effectively eliminates conflicts of interest within the exchange and significantly reduces the risk of digital assets being misappropriated or maliciously stolen.

It is another objective of the present disclosure to provide a digital asset management system, wherein a communication device held by a user has installed thereon a digital asset transaction application provided by a digital asset regulatory platform, thereby enabling the user to perform digital asset transaction operations via the digital asset transaction application. When the user initiates a digital asset transaction request via the digital asset transaction application, a digital asset regulatory module generates a time-based regulatory password and transmits the time-based regulatory password to the communication device. The user enters the time-based regulatory password through the digital asset transaction application and transmits the time-based regulatory password back to the digital asset regulatory module. Only after the digital asset regulatory module receives and verifies the correctness of the time-based regulatory password entered by the user does the digital asset regulatory module issue an authorized transaction instruction to the digital asset transaction module of the digital asset transaction platform and the financial transaction module of the financial account management platform to allow the digital asset transaction module and the financial transaction module to execute the digital asset transaction. Accordingly, verifying digital asset transactions by means of the time-based regulatory password has the following characteristics: the regulatory password is valid only for an extremely short duration, thereby effectively preventing password theft caused by prolonged exposure and guarding against the risk of unauthorized use. Furthermore, the regulatory password is generated based on a security algorithm and time synchronization, ensuring that a unique regulatory password is generated for each digital asset transaction request. Consequently, the objective of requiring real-time user authorization for every digital asset transaction is achieved, further enhancing the security and credibility of digital asset transactions.

To achieve the above objective, the present disclosure provide a digital asset management system, comprising: a financial account management platform comprising a financial transaction module, wherein the financial transaction module is configured to establish a financial account for a user and to manage identity authentication and financial transactions of the financial account; a digital asset transaction platform comprising a digital asset transaction module, wherein the digital asset transaction module is connected to the financial transaction module and is configured to receive user data transmitted from the financial transaction module or a communication device for the user to allow the user to apply for a transaction account, and to enable the user to perform a digital asset transaction operation through the transaction account; a digital asset regulatory platform comprising a digital asset regulatory module, wherein the digital asset regulatory module is network-connected to the financial transaction module and the digital asset transaction module, and is configured to establish a regulatory account for the user corresponding to the user’s financial account and transaction account; wherein the digital asset regulatory module is configured to hold in custody a private key corresponding to a digital asset, and the regulatory account is configured to store digital asset-related information; and a physical card provided to the user, the physical card comprising a first chip module and a second chip module; wherein, when the user intends to perform the digital asset transaction operation, the physical card is inserted into or brought into proximity with a chip reading device to activate the first chip module and the second chip module via the chip reading device; wherein, after the first chip module and the second chip module are activated, a first secure communication connection is established between the first chip module and the financial transaction module to enable the financial transaction module to perform financial identity authentication of the user; wherein, after the financial identity authentication of the user is successfully verified, a second secure communication connection is established between the second chip module and the digital asset regulatory module to enable the digital asset regulatory module to perform an authorization review of the digital asset transaction operation; and wherein, when both the financial identity authentication of the user and the authorization review for the digital asset transaction operation are successfully verified, the digital asset regulatory module issues an authorized transaction instruction to the digital asset transaction module so as to cause the digital asset transaction module to perform the digital asset transaction operation.

In one embodiment of the present disclosure, wherein when the user intends to perform the digital asset transaction operation, the user submits a digital asset transaction request to the digital asset transaction platform and the digital asset regulatory platform via the communication device; after receiving the authorized transaction instruction from the digital asset regulatory module, the digital asset transaction module generates digital asset transaction data based on the digital asset transaction request and transmits the digital asset transaction data to the digital asset regulatory module; the digital asset regulatory module signs the digital asset transaction data using the private key to generate a signed digital asset transaction data, and transmits the signed digital asset transaction data back to the digital asset transaction module; the digital asset transaction module broadcasts the signed digital asset transaction data to a blockchain to complete the digital asset transaction operation.

In one embodiment of the present disclosure, wherein the authorized transaction instruction issued by the digital asset regulatory module is an instruction signed with the private key.

In one embodiment of the present disclosure, wherein when the digital asset transaction operation is completed, the financial transaction module and the digital asset regulatory module jointly generate a transaction record comprising a financial signature and a regulatory signature, and the transaction record is stored in the regulatory account.

In one embodiment of the present disclosure, wherein the first chip module and the second chip module of the physical card are contact chips or wireless induction chips, respectively.

In one embodiment of the present disclosure, wherein the communication device used by the user is installed with a digital asset transaction application provided by the digital asset regulatory platform; when the user intends to perform the digital asset transaction operation, the digital asset transaction application connects to the digital asset regulatory module and transmits a digital asset transaction request thereto; whereupon the digital asset regulatory module transmits a time-based regulatory password to the communication device; the user inputs the time-based regulatory password via the digital asset transaction application and transmits the time-based regulatory password back to the digital asset regulatory module; and after receiving and verifying the time-based regulatory password, the digital asset regulatory module issues the authorized transaction instruction to the digital asset transaction module.

In one embodiment of the present disclosure, wherein the digital asset is a stablecoin, Bitcoin, other types of cryptocurrencies, or a central bank digital currency issued by various countries.

In one embodiment of the present disclosure, wherein the financial transaction module, in collaboration with the digital asset transaction module and the digital asset regulatory module, establishes network connections between the financial account, transaction account, and regulatory account of the user via an encrypted channel.

In one embodiment of the present disclosure, wherein the digital asset regulatory module includes a transaction ledger, and the transaction ledger records at least one digital asset transaction data.

In one embodiment of the present disclosure, wherein the digital asset regulatory platform is established by a digital asset regulatory authority, which is an institution established upon approval by a competent authority and possessing the capability to supervise securities.

In one embodiment of the present disclosure, wherein the first chip module stores financial authentication data of the user, and the financial transaction module performs the financial identity authentication of the user based on the financial authentication data of the user.

In one embodiment of the present disclosure, wherein the financial authentication data of the user includes a financial account identifier, a financial cryptographic key, or a financial identity credential.

In one embodiment of the present disclosure, wherein the first chip module stores biometric characteristics of the user, and the financial transaction module performs the financial identity authentication of the user based on the biometric characteristics of the user.

In one embodiment of the present disclosure, wherein authorization review of the digital asset transaction operation is based on authorization data provided by the second chip module, so as to confirm whether the user has a legal ownership of the digital asset to be transacted.

The present disclosure further provides a digital asset management method, comprising: receiving, via a financial transaction module in a financial account management platform, a request from a user to apply for a financial account; establishing, via the financial transaction module in the financial account management platform, the financial account of the user, and managing identity authentication and financial transactions of the user’s financial account; receiving, via a digital asset transaction module in a digital asset transaction platform, user data sent from the financial transaction module or from a communication device of the user, for the user to apply for a transaction account; establishing, via the digital asset transaction module in the digital asset transaction platform, the transaction account of the user; establishing, via a digital asset regulatory module of a digital asset regulatory platform, a regulatory account corresponding to the financial account and the transaction account; custodying, via the digital asset regulatory platform, a private key corresponding to a digital asset; providing a physical card including a first chip module and a second chip module; and performing a digital asset transaction operation, comprising: inserting or bringing the physical card close to a chip reading device; activating the first chip module and the second chip module via the chip reading device; establishing a secure communication connection between the first chip module and the financial transaction module to enable the financial transaction module to perform a financial identity authentication of the user; establishing a secure communication connection between the second chip module and the digital asset regulatory module to enable the digital asset regulatory module to perform an authorization review of the digital asset transaction operation; and issuing an authorized transaction instruction to the digital asset transaction module by the digital asset regulatory module when both the financial identity authentication and the authorization review of the digital asset transaction are successfully verified, so as to cause the digital asset transaction module to perform the digital asset transaction operation.

In one embodiment of the present disclosure, wherein the step of performing a digital asset transaction operation further comprises: submitting a digital asset transaction request to the digital asset transaction platform and the digital asset regulatory platform via the communication device; enabling the digital asset transaction module of the digital asset transaction platform, upon receiving the digital asset transaction request, to generate digital asset transaction data based on the digital asset transaction request and transmit the digital asset transaction data to the digital asset regulatory module; enabling the digital asset regulatory module to sign the digital asset transaction data using the private key to generate a signed digital asset transaction data and to transmit the signed digital asset transaction data back to the digital asset transaction module; and enabling the digital asset transaction module to broadcast the signed digital asset transaction data to a blockchain to complete the digital asset transaction operation.

In one embodiment of the present disclosure, wherein the steps of performing a digital asset transaction operation further comprises: installing a digital asset transaction application provided by the digital asset regulatory platform into the communication device; operating the digital asset transaction application to connect to the digital asset regulatory module and the digital asset transaction module; issuing a digital asset transaction request to the digital asset regulatory module via the digital asset transaction application; sending a time-based regulatory password to the communication device when the digital asset regulatory module receives the digital asset transaction request; inputting the time-based regulatory password via the digital asset transaction application of the communication device; and issuing, by the digital asset regulatory module of the digital asset regulatory platform, the authorized transaction instruction to the digital asset transaction module upon receiving and verifying the time-based regulatory password inputted via the digital asset transaction application of the communication device.

In one embodiment of the present disclosure, wherein the steps of the authorization review for the digital asset transaction operation comprise: verifying whether an authorization credential provided by the second chip module is valid; checking whether the regulatory account has a sufficient balance of digital assets; confirming whether the user has legal ownership of the digital assets; or confirming whether the digital asset transaction request complies with preset transaction limits or regulations.

### BRIEF DESCRIPTION OF THE DRAWINGS

FIG. 1 is a schematic structural diagram of a conventional digital asset management system.

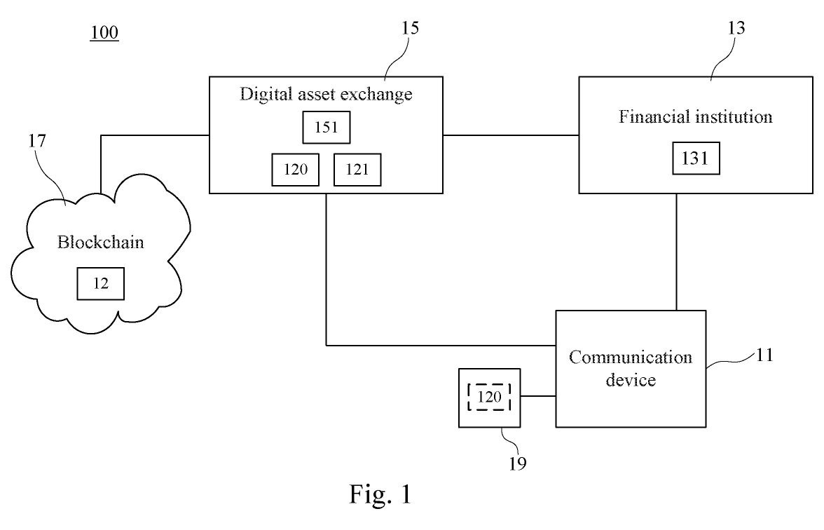

FIG. 2 is a schematic structural diagram illustrating a digital asset management system according to an embodiment of the present disclosure.

FIG. 3 is a schematic diagram illustrating a secure communication connection among a physical card, a digital asset transaction module of a digital asset transaction platform, and a digital asset regulatory module of a digital asset regulatory platform in accordance with the present disclosure.

### DETAILED DESCRIPTION OF THE PREFERRED EMBODIMENTS

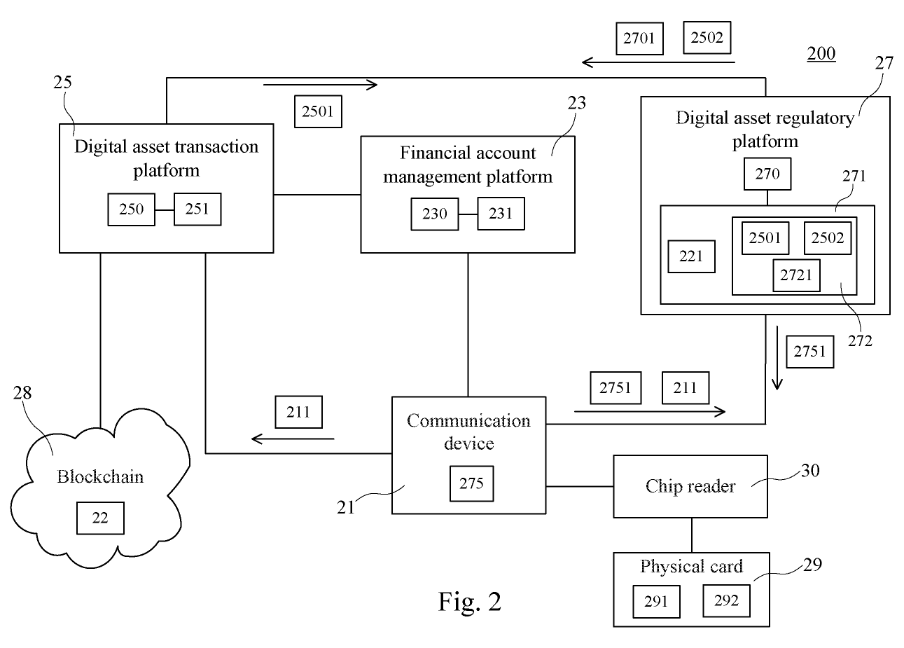

Please refer to FIG. 2, which is a schematic structural diagram illustrating a digital asset management system according to an embodiment of the present disclosure. The digital asset management system of the present disclosure is configured for digital asset security and the regulating of transaction behaviors. The digital assets may include stablecoins, Bitcoin, other types of cryptocurrencies, or central bank digital currencies (CBDCs) issued by various countries. As shown in FIG. 2, the digital asset management system 200 includes a communication device 21, a financial account management platform 23, a digital asset transaction platform 25, and a digital asset regulatory platform 27. The communication device 21 is held by a user and may also be a mobile communication device, a computer device, or a device with communication functions.

The financial account management platform 23 may be implemented as a server system managed by a bank or other financial service provider, and includes a financial transaction module 230. A user applies to the financial account management platform 23 for a financial account 231. In one embodiment, the user may connect to the financial transaction module 230 via the communication device 21 to issue an application request for the financial account 231 to the financial transaction module 230. After receiving the application request for the financial account 231, the financial transaction module 230 performs identity verification based on identification documents provided by the user, thereby establishing the financial account 231, and builds the user’s financial transaction data and manages subsequent financial transactions through the financial account 231.

The digital asset transaction platform 25 may be implemented as a server system managed by an entity that provides digital asset transaction services, such as Bitfinex, Binance, Coinbase, FTX, Bybit, Kraken, Bitstamp, or the Gemini exchange. The digital asset transaction platform 25 includes a digital asset transaction module 250. The digital asset transaction module 250 is network-connected to the financial transaction module 230, and the user may connect to the digital asset transaction module 250 via the communication device 21. The digital asset transaction module 250 is configured to receive user data transmitted from the communication device 21 or the financial transaction module 230 to allow the user to apply for a transaction account 251, and to enable the user with the ability to perform digital asset transaction operations via the transaction account 251.

The digital asset regulatory platform 27 includes a digital asset regulatory module 270. The digital asset regulatory module 270 is network-connected to the financial transaction module 230 and the digital asset transaction module 250, and is configured to receive user data provided by the communication device 21 or the financial transaction module 230, so as to establish a regulatory account 271 corresponding to the financial account 231 and the transaction account 251. Therein, the regulatory account 271 is available for the user to store at least one digital asset-related information 221, such as digital asset ownership, a blockchain address where the digital asset is stored, smart contract identification data, or other information related to digital asset management. In addition, the digital asset regulatory platform 27 may be implemented as a server system managed by a digital asset regulatory authority, which is an institution established upon approval by a competent authority and possessing the capability to supervise securities, thereby ensuring that the digital asset 22 under its custody possess security and compliance equivalent to those of traditional financial assets.

In the present disclosure, the financial transaction module 230, the digital asset transaction module 250, and the digital asset regulatory module 270 are functional modules implemented by integration of software systems and computer hardware equipment. The financial transaction module 230 performs management of the financial account 231, the digital asset transaction module 250 performs management of the transaction account 251 and processing of transactions involving the digital asset 22, and the digital asset regulatory module 270 performs management of the regulatory account 271 and regulates transactions of the digital asset 22.

Furthermore, address information and ownership information of the digital asset 22 are recorded in a distributed ledger of a blockchain 28. In addition, a private key 220 used to control and sign ownership transactions of the digital asset 22 is custodially managed by the digital asset regulatory platform 27 and securely stored in internal storage devices thereof.

The digital asset management system 200 further includes a physical card 29. The physical card 29 is issued to the user by the digital asset regulatory platform 27 and comprises a first chip module 291 and a second chip module 292. The first chip module 291 and the second chip module 292 may each be a contact-type chip or a wireless sensing chip. In the present disclosure, the physical card 29 serves as an authorization card for authorizing the initiation of transactions involving the digital asset 22. In one embodiment of the present disclosure, the communication device 21 is connected to an external chip reader 30, and the chip reader 30 reads or activates the first chip module 291 and the second chip module 292 of the physical card 29. Alternatively, in another embodiment of the present disclosure, the chip reader 30 is embedded in the communication device 21, such as an NFC reader, and the communication device 21 senses, reads, or activates the first chip module 291 and the second chip module 292 of the physical card 29 via the chip reader 30.

When the user intends to perform a digital asset transaction operation, the user submits a digital asset transaction request 211 (such as a request to purchase or sell the digital asset 22) to the digital asset transaction platform 25 and the digital asset regulatory platform 27 via the communication device 21, and inserts or brings the physical card 29 close to the chip reader 30 in order to activate the first chip module 291 and the second chip module 292 via the chip reader 30.

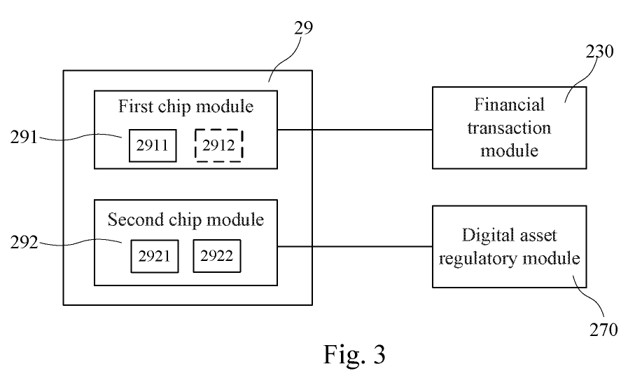

Referring simultaneously to FIGS. 2 and 3, the activated first chip module 291 establishes a secure communication connection with the financial transaction module 230 and instructs the financial transaction module 230 to perform the user’s financial identity verification. In one embodiment of the present disclosure, the first chip module 291 stores the user’s financial authentication data 2911, which includes a financial account identifier, a financial cryptographic key, or a financial credential. The financial transaction module 230 performs the user’s financial identity verification based on the financial authentication data 2911 provided by the first chip module 291. In another embodiment of the present disclosure, the first chip module 291 stores the user’s biometric information 2912, such as fingerprints, iris patterns, facial features, or other biometric data that can uniquely identify the user. The financial transaction module 230 performs the user’s financial identity verification based on the biometric information 2912 provided by the first chip module 291. After successful financial identity verification of the user, the activated second chip module 292 establishes a secure communication connection with the digital asset regulatory module 270 to enable the digital asset regulatory module 270 to authorize the digital asset transaction. The authorization by the digital asset regulatory module 270 at least includes: verifying whether an authorization credential 2921 provided by the second chip module 292 is valid; checking whether the regulatory account 271 (or its corresponding ledger record) has a sufficient balance of digital assets; confirming, based on the authorization information 2922 provided by the second chip module 292, whether the user has legal ownership of the digital asset 22 to be transacted; and confirming whether the digital asset transaction request 211 complies with predefined transaction restrictions or regulations (such as limitations on transaction counterparties, transaction frequency, or transaction amount).

When both the user’s financial identity verification and the authorization review of the digital asset transaction operation are successfully verified, the digital asset regulatory module 270 generates an authorized transaction instruction 2701 signed with the private key 220 and transmits it to the digital asset transaction module 250. After receiving the authorized transaction instruction 2701, the digital asset transaction module 250 performs the transaction of the digital asset 22 according to the user’s digital asset transaction request 211, generates corresponding on-chain digital asset transaction data 2501, and transmits the on-chain digital asset transaction data 2501 to the digital asset regulatory module 270. Upon receiving the on-chain digital asset transaction data 2501, the digital asset regulatory module 270 signs the on-chain digital asset transaction data 2501 using the managed private key 220 of the user to generate signed on-chain digital asset transaction data 2502, and returns the signed on-chain digital asset transaction data 2502 to the digital asset transaction module 250. Then, the digital asset transaction module 250 broadcasts the signed on-chain digital asset transaction data 2502 to the blockchain 28 to complete the corresponding digital asset transaction operation.

Furthermore, the digital asset regulatory module 270 is provided with a transaction ledger 272, which may be optionally stored in the regulatory account 271, and used for recording at least one on-chain digital asset transaction data 2501 and/or 2502. The content stored in the transaction ledger 272 further includes a final transaction record 2721 jointly generated by the financial transaction module 230 and the digital asset regulatory module 270. The final transaction record 2721 contains both a financial signature and a regulatory signature, verifying that the transaction of the digital asset 22 has been confirmed by the two independent entities 23 and 27. In addition, the financial transaction module 230, in coordination with the digital asset transaction module 250 and the digital asset regulatory module 270, establishes online connections among the financial account 231, the transaction account 251, and the regulatory account 271 of the user through an encrypted channel. Accordingly, the transaction ledger 272 can serve as a single source of truth for data reconciliation/data synchronization, ensuring that transaction data among the user’s financial account 231, transaction account 251, and regulatory account 271 remain synchronized and consistent, thereby preventing discrepancies in transaction records.

Furthermore, the communication device 21 is installed with a digital asset transaction application 275 provided by the digital asset regulatory platform 27. The user may perform digital asset transaction operations through the digital asset transaction application 275. When the user intends to perform a digital asset transaction operation, the digital asset transaction application 275 connects to the digital asset regulatory module 270, and then transmits a digital asset transaction request 211 to the digital asset regulatory module 270. Subsequently, the digital asset regulatory module 270 generates a time-based regulatory password (e.g., Time-based One-Time Password, TOTP) 2751, and transmits the regulatory password 2751 to the communication device 21. The user enters the regulatory password 2751 through a user interface of the digital asset transaction application 275 and transmits it back to the digital asset regulatory module 270. The digital asset regulatory module 270 issues an authorized transaction instruction 2701 to the digital asset transaction module 250 only after the digital asset regulatory module 270 receives and verifies the correctness of the regulatory password 2751 returned from the communication device 21, thereby allowing the digital asset transaction module 250 to perform the digital asset transaction operation. Accordingly, verifying digital asset transactions by means of the time-based regulatory password has the following characteristics: the regulatory password is valid only for a limited time, thereby effectively preventing password theft caused by prolonged exposure and guarding against the risk of unauthorized use. Furthermore, the regulatory password is generated based on a security algorithm and time synchronization, ensuring that a unique regulatory password is generated for each digital asset transaction request 211. Consequently, the objective of requiring real-time user authorization for every digital asset transaction is achieved, further enhancing the security and credibility of digital asset transactions.

Accordingly, when a user submits a purchase request for the digital asset 22 and completes the digital asset transaction operation, the user obtains the purchased digital asset 22. Subsequently, the ownership record of the digital asset 22 is synchronously updated in the ledgers of the blockchain 28, the transaction account 251, and the regulatory account 271, and the digital asset balances of the transaction account 251 and the regulatory account 271 are correspondingly increased. Alternatively, when the user submits a sell request for the digital asset 22 and completes the digital asset transaction operation, the user obtains the proceeds from selling the digital asset 22, and the proceeds are stored in the transaction account 251 or transferred to the financial account 231. At this time, the ledger of the blockchain 28 records the transfer-out of the digital asset 22, and the digital asset balances recorded in the ledgers of the transaction account 251 and the regulatory account 271 are correspondingly decreased.

Here, the transactions of the digital asset 22 are handled by the digital asset transaction platform 25, while the custody of the digital asset 22 (such as custody of a private key 220 corresponding to the digital asset 22) and the regulation of the transaction process are handled by the digital asset regulatory platform 27. By implementing this separation of duties between transaction and digital asset custody, the present invention achieves enhanced asset security and improved risk management. Compared to traditional models in which custody is managed internally by the exchange, the present disclosure ensures that transaction execution and custody of digital asset 22 are independent of each other. This separation effectively eliminates conflicts of interest of the exchange, significantly reduces the risk of misappropriation or malicious theft of the digital asset 22, and provides a more transparent and auditable asset supervision framework. In addition, the custody mechanism for the digital asset 22 of the present disclosure mitigates the risks associated with conventional personal wallets, such as the permanent loss of digital asset 22 due to hardware failure or operational errors.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A digital asset management system, comprising:
a financial account management platform comprising a financial transaction module, wherein the financial transaction module is configured to establish a financial account for a user and to manage identity authentication and financial transactions of the financial account;
a digital asset transaction platform comprising a digital asset transaction module, wherein the digital asset transaction module is connected to the financial transaction module and is configured to receive user data transmitted from the financial transaction module or a communication device for the user to allow the user to apply for a transaction account, and to enable the user to perform a digital asset transaction operation through the transaction account;
a digital asset regulatory platform comprising a digital asset regulatory module, wherein the digital asset regulatory module is network-connected to the financial transaction module and the digital asset transaction module, and is configured to establish a regulatory account for the user corresponding to the user’s financial account and transaction account; wherein the digital asset regulatory module is configured to hold in custody a private key corresponding to a digital asset, and the regulatory account is configured to store digital asset-related information; and
a physical card provided to the user, the physical card comprising a first chip module and a second chip module;
wherein, when the user intends to perform the digital asset transaction operation, the physical card is inserted into or brought into proximity with a chip reading device to activate the first chip module and the second chip module via the chip reading device;
wherein, after the first chip module and the second chip module are activated, a first secure communication connection is established between the first chip module and the financial transaction module to enable the financial transaction module to perform financial identity authentication of the user;
wherein, after the financial identity authentication of the user is successfully verified, a second secure communication connection is established between the second chip module and the digital asset regulatory module to enable the digital asset regulatory module to perform an authorization review of the digital asset transaction operation; and
wherein, when both the financial identity authentication of the user and the authorization review for the digital asset transaction operation are successfully verified, the digital asset regulatory module issues an authorized transaction instruction to the digital asset transaction module so as to cause the digital asset transaction module to perform the digital asset transaction operation.

2. The digital asset management system according to claim 1, wherein when the user intends to perform the digital asset transaction operation, the user submits a digital asset transaction request to the digital asset transaction platform and the digital asset regulatory platform via the communication device; after receiving the authorized transaction instruction from the digital asset regulatory module, the digital asset transaction module generates digital asset transaction data based on the digital asset transaction request and transmits the digital asset transaction data to the digital asset regulatory module; the digital asset regulatory module signs the digital asset transaction data using the private key to generate a signed digital asset transaction data, and transmits the signed digital asset transaction data back to the digital asset transaction module; the digital asset transaction module broadcasts the signed digital asset transaction data to a blockchain to complete the digital asset transaction operation.

3. The digital asset management system according to claim 1, wherein the authorized transaction instruction issued by the digital asset regulatory module is an instruction signed with the private key.

4. The digital asset management system according to claim 1, wherein when the digital asset transaction operation is completed, the financial transaction module and the digital asset regulatory module jointly generate a transaction record comprising a financial signature and a regulatory signature, and the transaction record is stored in the regulatory account.

5. The digital asset management system according to claim 1, wherein the first chip module and the second chip module of the physical card are contact chips or wireless induction chips, respectively.

6. The digital asset management system according to claim 1, wherein the communication device used by the user is installed with a digital asset transaction application provided by the digital asset regulatory platform; when the user intends to perform the digital asset transaction operation, the digital asset transaction application connects to the digital asset regulatory module and transmits a digital asset transaction request thereto; whereupon the digital asset regulatory module transmits a time-based regulatory password to the communication device; the user inputs the time-based regulatory password through the digital asset transaction application and transmits the time-based regulatory password back to the digital asset regulatory module; and after receiving and verifying the time-based regulatory password, the digital asset regulatory module issues the authorized transaction instruction to the digital asset transaction module.

7. The digital asset management system according to claim 1, wherein the digital asset is a stablecoin, Bitcoin, other types of cryptocurrencies, or a central bank digital currency issued by various countries.

8. The digital asset management system according to claim 1, wherein the financial transaction module, in collaboration with the digital asset transaction module and the digital asset regulatory module, establishes network connections between the financial account, transaction account, and regulatory account of the user via an encrypted channel.

9. The digital asset management system according to claim 1, wherein the digital asset regulatory module includes a transaction ledger, and the transaction ledger records at least one digital asset transaction data.

10. The digital asset management system according to claim 1, wherein the digital asset regulatory platform is established by a digital asset regulatory authority, which is an institution established upon approval by a competent authority and possessing the capability to supervise securities.

11. The digital asset management system according to claim 1, wherein the first chip module stores financial authentication data of the user, and the financial transaction module performs the financial identity authentication of the user based on the financial authentication data of the user.

12. The digital asset management system according to claim 11, wherein the financial authentication data of the user includes a financial account identifier, a financial cryptographic key, or a financial identity credential.

13. The digital asset management system according to claim 1, wherein the first chip module stores biometric characteristics of the user, and the financial transaction module performs the financial identity authentication of the user based on the biometric characteristics of the user.

14. The digital asset management system according to claim 1, wherein authorization review of the digital asset transaction operation is based on authorization data provided by the second chip module, so as to confirm whether the user has a legal ownership of the digital asset to be transacted.

15. A digital asset management method, comprising:
receiving, via a financial transaction module in a financial account management platform, a request from a user to apply for a financial account;
establishing, via the financial transaction module in the financial account management platform, the financial account of the user, and managing identity authentication and financial transactions of the user’s financial account;
receiving, via a digital asset transaction module in a digital asset transaction platform, user data sent from the financial transaction module or from a communication device of the user, for the user to apply for a transaction account;
establishing, via the digital asset transaction module in the digital asset transaction platform, the transaction account of the user;
establishing, via a digital asset regulatory module of a digital asset regulatory platform, a regulatory account corresponding to the financial account and the transaction account;
custodying, via the digital asset regulatory platform, a private key corresponding to a digital asset;
providing a physical card including a first chip module and a second chip module; and
performing a digital asset transaction operation, comprising:
inserting or bringing the physical card close to a chip reading device;
activating the first chip module and the second chip module via the chip reading device;
establishing a secure communication connection between the first chip module and the financial transaction module to enable the financial transaction module to perform a financial identity authentication of the user;
establishing a secure communication connection between the second chip module and the digital asset regulatory module to enable the digital asset regulatory module to perform an authorization review of the digital asset transaction operation; and
issuing an authorized transaction instruction to the digital asset transaction module by the digital asset regulatory module when both the financial identity authentication and the authorization review of the digital asset transaction are successfully verified, so as to cause the digital asset transaction module to perform the digital asset transaction operation.

16. The digital asset management method according to claim 15, wherein the step of performing a digital asset transaction operation further comprises:
submitting a digital asset transaction request to the digital asset transaction platform and the digital asset regulatory platform via the communication device;
enabling the digital asset transaction module of the digital asset transaction platform, upon receiving the digital asset transaction request, to generate digital asset transaction data based on the digital asset transaction request and transmit the digital asset transaction data to the digital asset regulatory module;
enabling the digital asset regulatory module to sign the digital asset transaction data using the private key to generate a signed digital asset transaction data and to transmit the signed digital asset transaction data back to the digital asset transaction module; and
enabling the digital asset transaction module to broadcast the signed digital asset transaction data to a blockchain to complete the digital asset transaction operation.

17. The digital asset management method according to claim 15, wherein the authorized transaction instruction issued by the digital asset regulatory module is an instruction signed with the private key.

18. The digital asset management method according to claim 15, wherein when the digital asset transaction operation is completed, the financial transaction module and the digital asset regulatory module jointly generate a transaction record comprising a financial signature and a regulatory signature, and the transaction record is stored in the regulatory account.

19. The digital asset management method according to claim 15, wherein the steps of performing a digital asset transaction operation further comprises:
installing a digital asset transaction application provided by the digital asset regulatory platform into the communication device;
operating the digital asset transaction application to connect to the digital asset regulatory module and the digital asset transaction module;
issuing a digital asset transaction request to the digital asset regulatory module via the digital asset transaction application;
sending a time-based regulatory password to the communication device when the digital asset regulatory module receives the digital asset transaction request;
inputting the time-based regulatory password via the digital asset transaction application of the communication device; and
issuing, by the digital asset regulatory module of the digital asset regulatory platform, the authorized transaction instruction to the digital asset transaction module upon receiving and verifying the time-based regulatory password inputted via the digital asset transaction application of the communication device.

20. The digital asset management method according to claim 15, wherein the first chip module stores financial authentication data of the user or biometric characteristics of the user, and the financial transaction module performs the financial identity authentication of the user based on the financial authentication data of the user or the biometric characteristics of the user.

21. The digital asset management method according to claim 15, wherein the steps of the authorization review for the digital asset transaction comprise:
verifying whether an authorization credential provided by the second chip module is valid;
checking whether the regulatory account has a sufficient balance of digital assets;
confirming whether the user has legal ownership of the digital assets; or
confirming whether the digital asset transaction request complies with preset transaction limits or regulations.

22. The digital asset management method according to claim 15, further comprising:
establishing an online connection among the financial account of the user and the corresponding transaction account and the regulatory account.

23. The digital asset management method according to claim 15, further comprising:
establishing a transaction ledger to the regulatory account via the digital asset regulatory module; and
recording at least one digital asset transaction data to the transaction ledger.
